(19) United States
(12) Patent Application Publication
(10) Pub. No.: US 2016/0129965 A1
(43) Pub. Date: May 12, 2016

(54) TRAINING SCOOTER

(71) Applicant: SMART TRIKE MNF. PTE. LTD., Singapore (SG)

(72) Inventors: Yoram Baron, Moshav Nir Israel (IL); Gil Nachmany, Pardes Hanna-Karkur (IL); Alexey Rubinchik, Holon (IL)

(73) Assignee: SMART TRIKE MNF. PTE. LTD.

(21) Appl. No.: 15/000,466

(22) Filed: Jan. 19, 2016

Related U.S. Application Data
(63) Continuation of application No. PCT/IB2015/056376, filed on Aug. 23, 2015.
(60) Provisional application No. 62/045,757, filed on Sep. 4, 2014.

(51) Int. Cl. B62K 21/10; B62K 3/00; B62H 7/00

(52) U.S. Cl. CPC B62K 21/10; B62H 7/00; B62K 3/002

(57) ABSTRACT

The present invention relates to a scooter having a lockable steering mechanism comprising: (a) a rigid frame; (b) at least one rotatable rear wheel connected to said frame; (c) at least one front wheel support swayably connected to said frame; (d) a pair of front wheels each rotatably connected about said at least one front wheel support; (e) a locking mechanism for locking and unlocking said at least one front wheel support in relations to said frame; (f) a head bar attached to said frame for steering said scooter when said locking mechanism is unlocked; (g) restraining means for returning said at least one front wheel support to its initial position in relations to said frame when said locking mechanism is unlocked.

### TECHNICAL FIELD

The present invention relates to riding vehicles.

### BACKGROUND

As of today, scooters are widely used for transportation and recreation, by children and adults alike. The presently available scooters can be divided into 2 main categories: the 2-wheels scooters and the 3(or more)-wheels scooters, where the 3-wheels scooters are typically more stable, and can stand upright on the floor by themselves. The category of the 3-wheels scooters can be divided into 2 sub-categories: the scooters having 1 front wheel and the scooters having 2 front wheels. The scooters, belonging to this last sub-category of 2-front-wheels-scooters, typically have some kind of frontal steering mechanism for steering the 2 front wheels of the scooter right or left. One of the advantages, of these 2-front-wheels-scooters, is that their drivability is more similar to that of a skateboard.

US 2012181773 discloses a scooter for infants which is equipped with a seat and steering means. The disclosed scooter comprises a plastic footboard, a front chassis support and a rear chassis support. The rear chassis support comprises an axle about which a relatively small rear wheel rotates. The disclosed scooter furthermore includes a seat which is preferably fixed to the steering bar of the vehicle, and wherein the vehicle includes gripping at the steering bar. The front chassis support of the vehicle includes a steering mechanism which permits to steer the vehicle by ways of shifting of weight. Nevertheless, the disclosed scooter has limited use.

AU 2010224439 discloses a drift scooter comprising a longitudinal frame including opposed leading and trailing end portions. The disclosed steering assembly is pivotably disposed on the leading end portion and includes a transverse member with two wheels rotatably supported on opposite ends of the transverse member. A stem is fixed in perpendicular orientation relative to the transverse member and a handlebar is connected to the stem. A rear wheel assembly is pivotably disposed on the trailing end portion, wherein the wheel assembly pivots about an upwardly extending pivot axis. The rear wheel assembly is preferably biased toward a centered position, aligned with a centerline of the frame. As disclosed, resilient member is connected between the frame and a leading portion of the caster. The resilient member may be in the form of an adjustable extension spring. Nevertheless, the disclosed scooter has complicated steering.

It would therefore be desired to propose a system void of these deficiencies.

### SUMMARY

It is an object of the present invention to provide a scooter that may be used for training beginning riders.

It is another object of the present invention to provide a scooter which has a lockable steering mechanism.

It is still another object of the present invention to provide a scooter having an adaptable steering restraint which can be modified as the rider gains experience, for creating a versified experience for the rider.

It is still another object of the present invention to provide a scooter having an adaptable steering elasticity restraint for facilitation of a linear type of movement for a trained user who is looking for a unique riding experience

It is still another object of the present invention to provide a scooter having a changeable footboard cover.

Other objects and advantages of the invention will become apparent as the description proceeds.

The present invention relates to a scooter having a lockable steering mechanism comprising: (a) a rigid frame; (b) at least one rotatable rear wheel connected to said frame; (c) at least one front wheel support swayably connected to said frame; (d) a pair of front wheels each rotatably connected about said at least one front wheel support; (e) a locking mechanism for locking and unlocking said at least one front wheel support in relations to said frame; (f) a head bar attached to said frame for steering said scooter when said locking mechanism is unlocked; (g) restraining means for returning said at least one front wheel support to its initial position in relations to said frame when said locking mechanism is unlocked.

In one embodiment, the locking of the steering mechanism is done by turning a turn button.

In one embodiment, the locking of the steering mechanism is done by pushing a button.

In one embodiment, the restraining means comprise at least one spring.

In one embodiment, the restraining means comprise at least one elastomer.

In one embodiment, the elastomer has an “8” like shape.

In one embodiment, the elastomer has a “B” like shape.

Preferably, the elastomer is replaceable.

Preferably, the footboard is replaceable.

In one embodiment, the scooter further comprises a seat on the head bar.

Preferably, the scooter comprises a handlebar which is attached to head bar.

Preferably, the scooter has a brake.

In one embodiment, the locking mechanism comprises one protrusion.

In one embodiment, the locking mechanism comprises two pins.

### BRIEF DESCRIPTION OF THE DRAWINGS

The accompanying drawings, and specific references to their details, are herein used, by way of example only, to illustratively describe some of the embodiments of the invention.

In the drawings:

FIG. 1 is a diagram of a scooter for riding, according to an embodiment of the invention.

FIG. 2 is a diagram of some of the inner parts of the scooter, according to an embodiment of the invention.

FIG. 3 is a diagram of some of the parts of the steering mechanism, according to an embodiment of the invention.

FIG. 4a, is a diagram of some of the parts of the steering locking mechanism, according to an embodiment of the invention.

FIG. 4b, is another diagram of some of the parts of the steering locking mechanism, according to an embodiment of the invention.

FIG. 4c, is another diagram of some of the parts of the steering locking mechanism, according to an embodiment of the invention.

FIG. 4d, is another diagram of some of the parts of the steering locking mechanism, according to an embodiment of the invention.

FIG. 5 depicts a turn button, according to an embodiment of the invention.

FIG. 6 is a side view diagram of a scooter with a seat for sitting and riding, according to an embodiment of the invention.

FIG. 7 depicts some of the inner parts of another scooter, according to an embodiment of the invention.

FIG. 8 depict some of the parts of another steering locking mechanism, according to an embodiment of the invention.

FIG. 9 is a rear view diagram of a scooter for riding, according to another embodiment of the invention.

FIG. 10 depicts some of the parts of the steering mechanism, according to another embodiment of the invention.

### DETAILED DESCRIPTION

The terms of “front”, “rear”, “down”, “up”, “bottom”, “upper”, “horizontal”, “vertical”, “right”, “left” or any reference to sides or directions are used throughout the description for the sake of brevity alone and are relative terms only and not intended to require a particular component orientation.

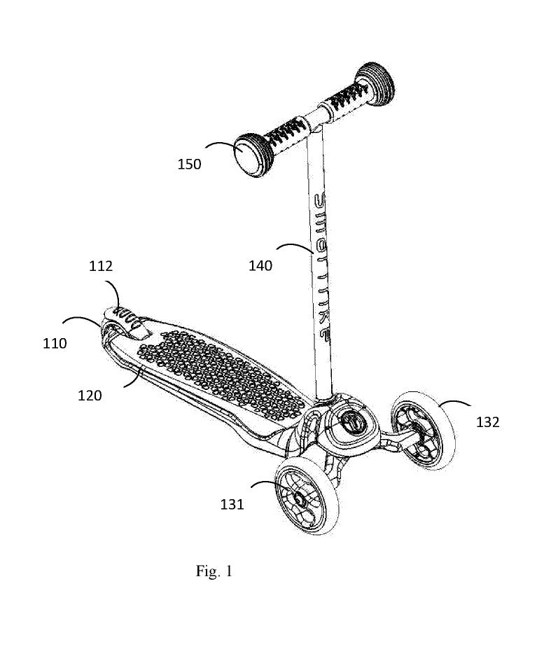

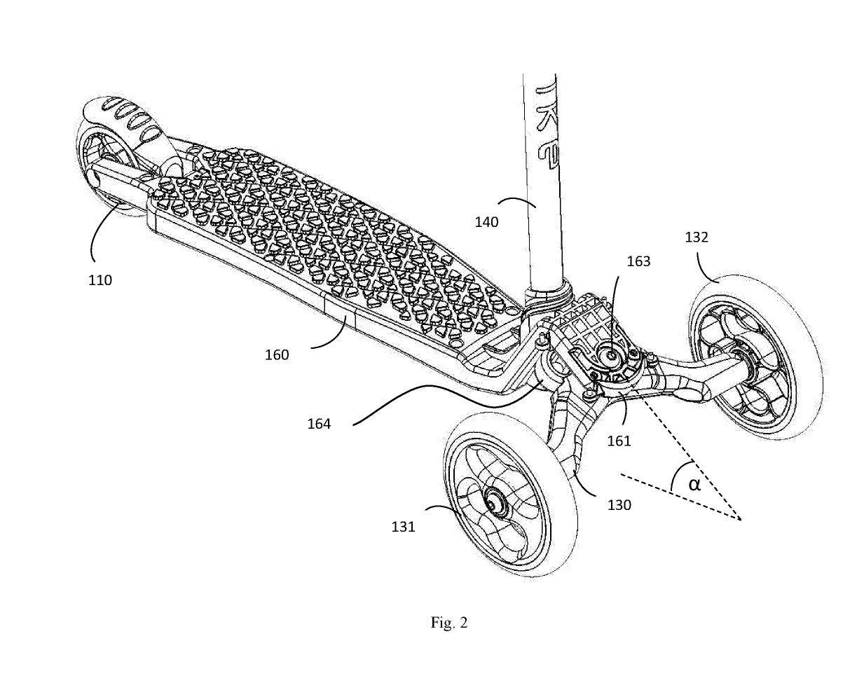

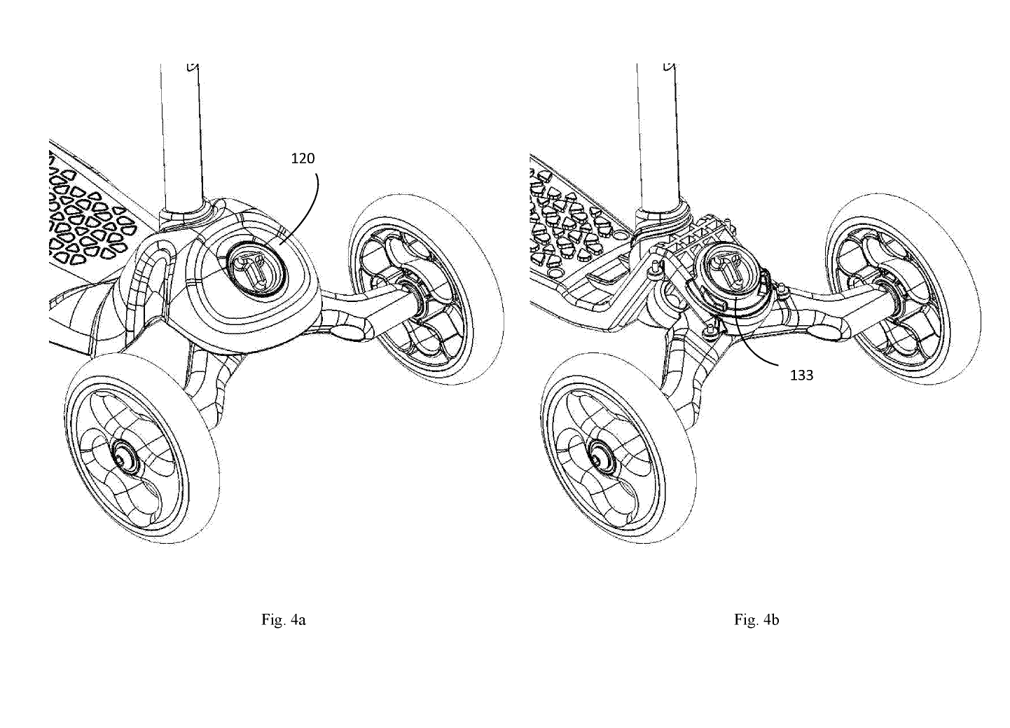

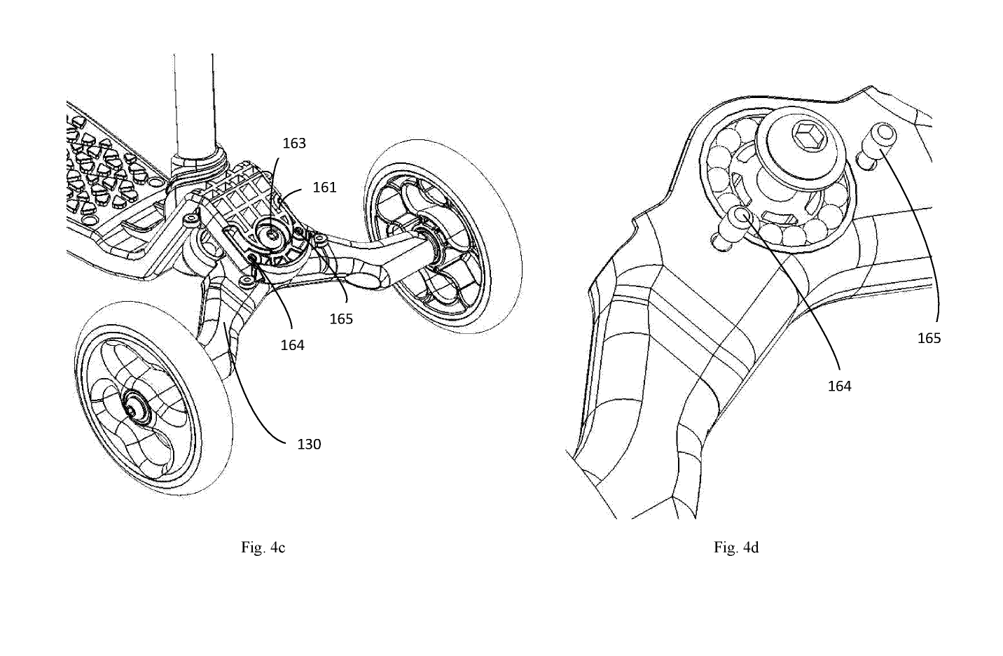

FIG. 1 is a diagram of a scooter for riding, according to an embodiment of the invention. The scooter may have 3 wheels or more and may be used for travel, recreation, for training new riders, or for any other activity. Due to the scooter's wheels configuration, where, for example, the footboard 120 is located between 1 rear wheel 110 and 2 front wheels 131 and 132, a rider may mount the footboard 120 stably without fear of falling. The wheels, and their configured location in relations to the footboard 120, may be arranged for stably supporting the center weight of the footboard 120 and the weight of a rider, according to one embodiment. The scooter may be ridden by placing one foot on the footboard 120 and pushing the scooter forward with the other foot while holding the handlebar 150 which is attached to head bar 140, according to an embodiment. Furthermore, the scooter may have 2 modes: active steering mode and training mode, according to an embodiment. In the active steering mode the rider may steer left or right by shifting his weight and tilting the head bar 140 right or left accordingly, as described in greater detailed in relations to FIG. 2. In the training mode, the scooter's front steering mechanism may be locked in a straight direction movement position, effectively limiting the scooter's front wheels to roll frontwards or backwards only, e.g. limiting the scooter's front wheels to parallel orientation only—in relations to the back wheel. The locking mechanism of the training mode is described in greater detailed in relations to FIGS. 4c-4d, according to an embodiment. In the training mode, any beginning rider can start learning to ride the scooter without the need to learn to steer the scooter as well at the same time. Thus, once the rider has mastered the art of riding the scooter straight he may change the scooter to the active steering mode, i.e. unlock the locking mechanism of the steering mechanism, for learning to steer the scooter left and right as well.

In one embodiment the scooter may have a knob instead of handlebar 150, described in relations to FIG. 1. Thus the user may use the knob for tilting the head bar 140.

In some embodiments the scooter may have a brake for stopping its advance while riding. In one embodiment, a movable covering 112, as depicted in FIG. 1, may be moveably attached to the frame over the scooter's rear wheel 110 without touching the rear wheel 110. However, when the rider wishes to brake, he may step on the covering 112 for slowing down and/or stopping the scooter during riding.

FIG. 2 depicts some of the inner parts of the scooter, according to an embodiment of the invention. One part of the scooter may be the frame 160 which may be located under the footboard, described in relations to FIG. 1. The frame 160 may be made of metal, carbon, plastic, wood or any other rigid material, or any other combination thereof, capable of supporting the weight of a rider. In one embodiment, the frame is capable of supporting the weight of up to 20 Kg. In another embodiment the frame is capable of supporting the weight of up to 50 Kg. In another embodiment the frame is capable of supporting the weight of up to 120 Kg. The front part 161, of the frame 160, may have a forward slope of an angle α, between the frame's front part 161 slope and the ground, as viewed from the side of the scooter. In one embodiment, the angle α may be approximately 30°. In another embodiment the angle α, may be between 20° and 40°. In yet another embodiment the angle α, may be between 10° and 50°. In one embodiment, the frame's front part 161 may also have a hole into which a pivot, such as pin 163, may be inserted for swayably connecting the front wheel support 130, effectively allowing the front wheel support 130 to rotate back and forth and/or left and right and/or in and out in relation to the frame 160. In one embodiment, the pin 163 may be a screw which is held by a nut (not shown), or may be any other mechanism which can act as a pivot for the front wheel support 130. Thus, the front wheel support 130 may sway left or right around the pivot in relations to the frame 160. In some embodiments, the axis of the pivot may be perpendicular to the frame's front part 161.

According to an embodiment, the frame's front part 161 forward slope, as described in relations to FIG. 2, is also part of the steering mechanism of the scooter. In this embodiment, the frame's front part 161 forward slope contributes to the successful translation of the tilting applied, right or left, on the frame 160 to the alignment of the front wheel support 130 and the front wheels 131 and 132 accordingly. For example, by tilting the head bar 140 towards the right, the right side of frame 160 is lowered, however due to its frontal sloping angle the right side of front wheel support 130 is pushed backwards, i.e. towards the rear of the scooter, while its left side is pushed frontwards effectively aligning the front wheels for a right turn. Thus the steering of right and left may be achieved by simple tilting of the head bar 140. In one embodiment, restraining means may be used for returning the front wheel support 130 to its initial position, in relations to the frame 160, after the tilting has stopped. For example, elastomer 164 may be part of the restraining means. Since elastomer 164 has a certain elasticity, he may be placed between frame 160 and front wheel support 130 for applying pressure on the front wheel support 130 to sway back into its basic position relative to the frame 160, e.g. to the straight position.

The front right wheel 131 may be connected about the right side of the front wheel support 130 where the front left wheel 132 may be connected about the left side of the front wheel support 130. In one embodiment, the front wheels 131 and 132 may be similar to typical scooter wheels having a size of 120 mm, made of Rim material polypropylene and tire material polyurethane, where their axis is 8 mm long and their marked Max load capability is 20 Kg or any other rotatable wheel which may serve as one of the scooter's front wheels.

In one embodiment, Both front wheels 131 and 132 may each be rotatably connected to its own axle where the axles may be connected to the sides of the front wheel support 130. In another embodiment, Both front wheels 131 and 132 may be rotatably connected directly to the front wheel support.

A rear wheel 110 may be rotatably connected to the frame 160 in any of the known techniques, for example the axle of the rear wheel 110 may be attached with screws to the rear side of frame 160 in designated holes. In one embodiment, the rear wheel 110 may be similar to a typical scooter wheel having a size of 80 mm, made of Rim material polypropylene and tire material polyurethane, where its axis is 8 mm and its marked Max load capability is 20 Kg, or any other rotatable wheel which may serve as the scooter's rear wheel.

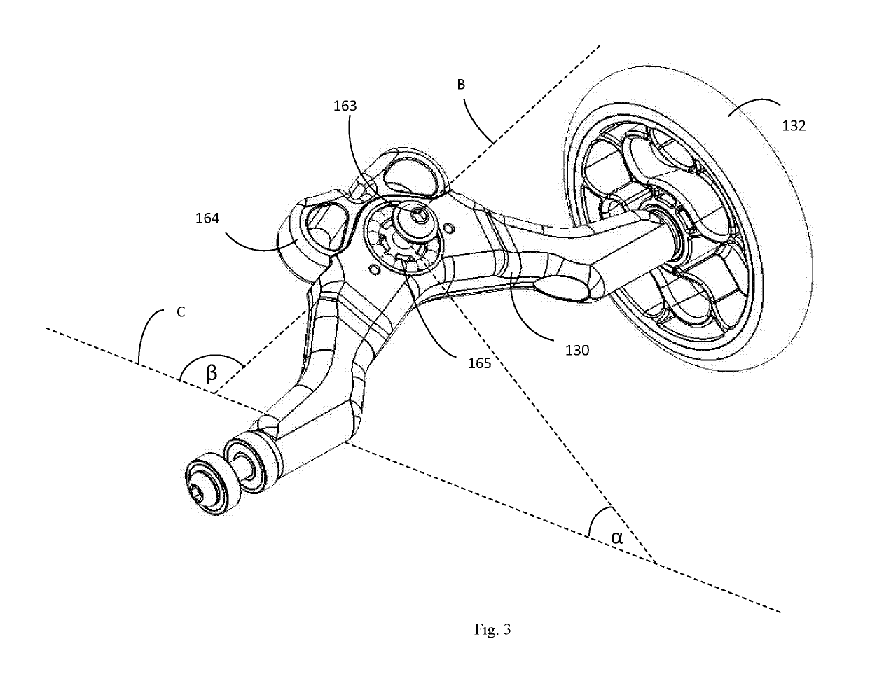

FIG. 3 depicts some of the parts of the steering mechanism, according to an embodiment of the invention. As described in relations to FIG. 2 the front wheel support 130 may have a left front wheel 132 and a right front wheel (not shown) both rotatably attached to its sides. The front wheel support 130 may have a bearing 165 for a smoother swaying, of the front wheel support 130 in relation to the frame. The bearing 165 may be located around the pin 163 and may be a ball bearing or any other of type of bearing capable of smoothing the swayable movement of the front wheel support 130. The angle β between the axis B of the pivot of the front wheel support 130, e.g. pin 163, and the ground C may be around 120° when viewed from the sides of the scooter, according to one embodiment. In another embodiment, the angle β, may be between 110° and 130°. In yet another embodiment, the angle β, may be between 50° and 140°. The elastomer 164 may have different shapes and may be made of different elastic material such as polyurethane for pushing and returning the front wheel support 130 to its base position in relations the frame. According to one embodiment, the elastomer 164 has a “B” like shape where this unique shape provides additional elasticity to the active steering. According to one embodiment, the elastomer 164 has an “8” like shape where this unique shape provides additional elasticity to the dynamic active steering. Since the elastomer 164 may be tightly placed, between the frame and the front wheel support 130, the tilting of the head bar of the scooter and the swaying of the front wheel support 130 may deform the elastomer 164 shape. On the other hand, due to the elastomer's 164 intrinsic characteristics, any deformation to its shape causes it to apply pressure to return to its initial formation, and thus pressure may be applied to the front wheel support 130 to sway it back to its base position in relations to the frame, once the tilting has stopped. In one embodiment, the Shore hardness of the elastomer 164 may be between 70-85, where the Shore hardness scale is typically used to define the hardness of polymers, elastomers, and rubbers, where hardness may be defined as a material's resistance to permanent indentation.

In some embodiments other restraining means may be used for returning the front wheels axles support to its initial position, in relations to the frame, such as a spring or springs disposed between the front wheel support and the frame. In one embodiment at least one torsion spring or any other type of spring is held on one of its sides by the frame and on its other side by the front wheels axles support.

In one embodiment, restraining means may be used for returning the front wheel support 130 to its initial position, in relations to the frame 160, after the tilting has stopped, as described in relations to FIGS. 2 and 3. For example, elastomer 164 may be part of the restraining means. Since elastomer 164 has a certain elasticity, he may be placed between frame 160 and front wheel support 130 for applying pressure on the front wheel support 130 to sway back into its basic position relative to the frame 160, e.g. to the straight position.

In one of the embodiments the elastomer 164, placed between frame 160 and front wheel support 130 as described in relations to FIGS. 2 and 3, for pushing the front wheel support 130 back into its basic position relative to the frame 160, maybe replaced by a different elastomer having the same shape but not the same elasticity. Thus the elasticity of the steering and the derivability of the scooter may be changed. In one embodiment a fairly rigid elastomer 164 is placed between frame 160 and front wheel support 130 for training a new rider. If the elastomer 164 is fairly rigid the steering is much more rigid and thus easier to hold steady and stable. However, once the rider has gained experience and self-assurance, the fairly rigid elastomer 164 may be changed with a softer elastomer, thus providing a much more elastic steering and derivability for a versified user experience.

FIGS. 4a, 4b, 4c and 4d depict some of the parts of the steering locking mechanism, according to an embodiment of the invention. The locking mechanism may be used for locking and unlocking the front wheel support in relations to the frame. FIG. 4a depicts the front of the scooter, as described in relations to FIG. 1, with the footboard 120. FIG. 4b depicts the front of the scooter as described in relations to FIG. 4a, however, without the footboard 120. As depicted, the turn button 133 may be turned for locking the steering mechanism, or turned back for unlocking the steering mechanism. As described in relations to FIG. 1, locking of the steering mechanism limits the scooter's front wheels to a straight movement position, according to one embodiment. Other embodiments of a locking button are possible as well such as a push button, pull button, etc. FIG. 4c depicts the front of the scooter as described in relations to FIG. 4b, however, without the turn button 133. As depicted and described in relations to FIG. 2, the front wheel support 130 is swayably attached to the frame around a pivot, such as pin 163, e.g. a screw. Nevertheless, in this diagram the steering mechanism is locked such as by the 2 pins 164 and 165 which are located inside designated holes both in the frame's front part 161 and the front wheel support 130. Thus when the steering mechanism is locked the 2 pins, 164 and 165, may be held in the frame's front part 161 and in front wheel support 130 simultaneously to disallow the swaying of the front wheel support 130 in relations to the frame's front part 161. FIG. 4d depicts the 2 pins, 164 and 165, in the front wheel support 130 during the locking. In one embodiment, springs may be attached to the 2 pins, 164 and 165, for pulling the pins inside the frame's front part 161. Thus, when the turn button 133 is turned to unlocking, both pins may be pulled out into the frame's front part 161, effectively clearing their holes in the front wheel support 130, and thus allowing the swaying of the front wheel support 130 in relations to the frame.

In one embodiment a single pin or protrusion may be used in the locking mechanism for locking and unlocking the front wheel support in relations to the frame. In one embodiment the pin or protrusion may be pushed or pulled for locking and unlocking the front wheel support in relations to the frame.

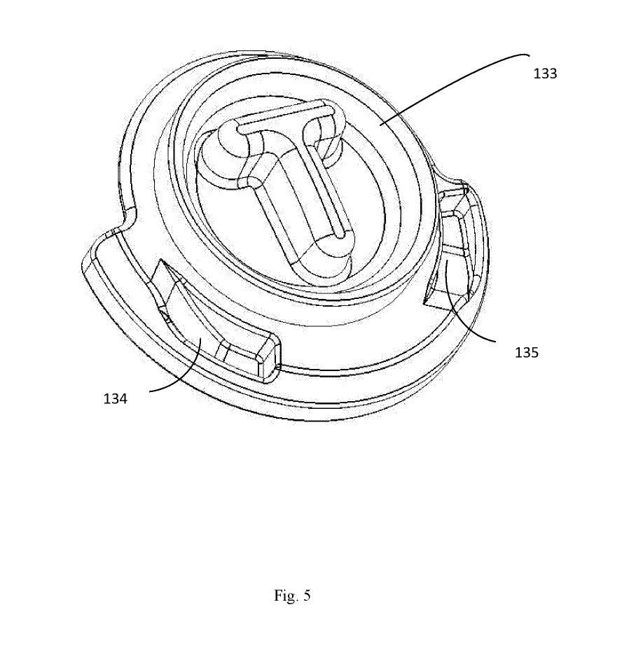

FIG. 5 depicts a turn button 133, according to an embodiment of the invention. For example, turning the turn button 133 clockwise may cause the locking of the steering mechanism where turning the turn button 133 counterclockwise may cause the unlocking of the steering mechanism. The turn button 133 may have 2 slopes, 134 and 135, for alternating between pressing and un-pressing the heads of the 2 pins 164 and 165, described in relations to FIG. 4d. When the turn button 133, is turned clockwise, the slopes 134 and 135, press the 2 pins, 164 and 165 accordingly, into the designated holes in the front wheel support 130, described in relations to FIG. 4c. Thus if the turn button 133 is turned into the locking position the 2 pins are held in place effectively locking the front wheel support 130 in relations to the frame's front part 161. However, when the turn button 133 is turned into the unlocking position the 2 pins are un-pressed thus allowing the springs to pull them out of the front wheel support 130 effectively unlocking the front wheel support 130 in relations to the frame's front part 161.

In one embodiment the footboard 120, described in relations to FIG. 1, may be a detachable footboard. In an embodiment the footboard 120 may be changed with a different color footboard according to the user's preference.

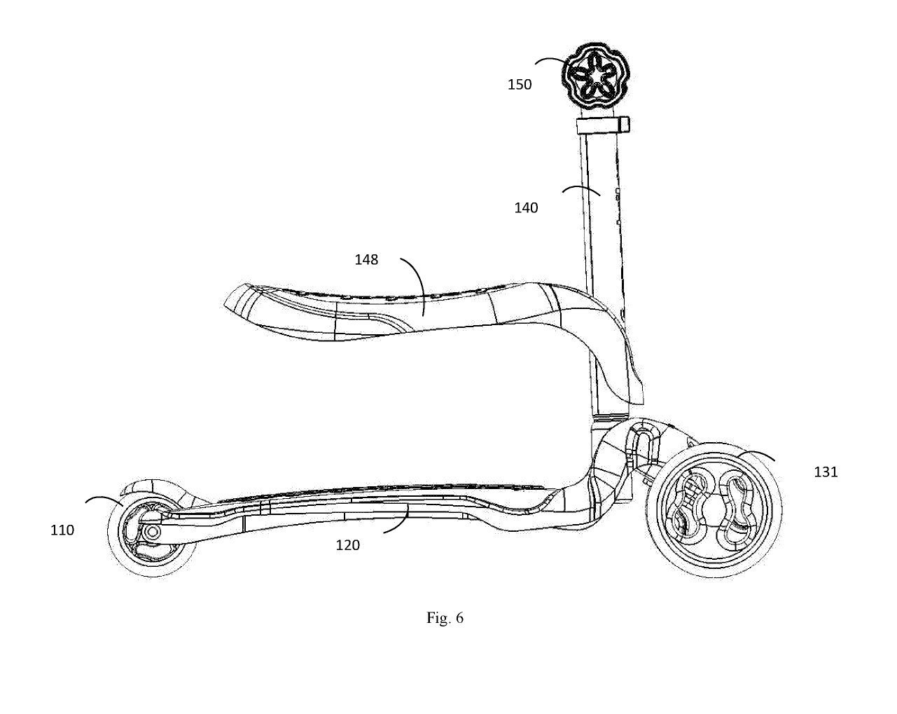

FIG. 6 is a side view diagram of a scooter with a seat for sitting and riding, according to an embodiment of the invention. In this embodiment a seat 148 may be added and held on the head bar 140. The seat 148 may be used by the rider for sitting while he is riding the scooter. The rider may sit and ride the scooter while its steering mechanism, as described in relations to FIG. 2, is locked or unlocked. The seat may be held by a screw, a nut, by pins connected to the seat which are inserted into the head bar 140, or in any other way.

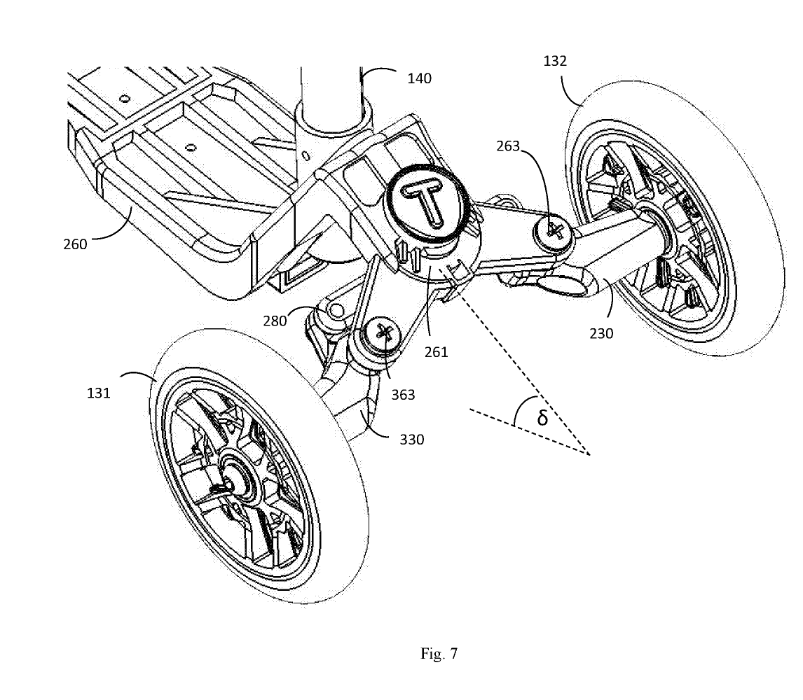

FIG. 7 depicts some of the inner parts of a scooter, according to another embodiment of the invention. One part of the scooter may be the frame 260 which may be located under the footboard, described in relations to FIG. 1. The front part 261, of the frame 260, may have a forward slope of an angle δ, between the frame's front part 261 slope and the ground, as viewed from the side of the scooter. In one embodiment, the angle δ may be approximately 30°. In another embodiment the angle δ, may be between 20° and 40°. The frame's front part 261 may also have 2 holes into which pivots, such as pins 263 and 363, may be inserted for swayably connecting the front wheel support parts 230 and 330, effectively allowing the front wheel support parts 230 and 330 to rotate back and forth and/or left and right and/or in and out in relation to the frame 260. In one embodiment, the pins 263 and/or 363 may be screws which are held by a nuts (not shown), or may be any other mechanisms which can act as pivots for the front wheel supports 230 and/or 330. Thus, the front wheel supports 230 and 330 may each sway left or right around their pivot in relations to the frame 260. In some embodiments, the axis of the pivots may be perpendicular to the frame's front part 261.

According to an embodiment, the frame's front part 261 forward slope, as described in relations to FIG. 7, is also part of the steering mechanism of the scooter. In this embodiment, the frame's front part 261 forward slope contributes to the successful translation of the tilting applied, right or left, on the frame 260 to the alignment of the front wheel supports 230 and 330, and hence the alignment of the front wheels 131 and 132 accordingly. In addition, the front wheel support parts 230 and 330 may be connected by one or more front wheel support bars, such as bar 280, for coordinating the rotation and alignment of the front wheel support parts 230 and 330. Thus the parts 230 330 and 280 can act together, inter alia, as a front wheel support. For example, by tilting the head bar 140 towards the right, the right side of frame 260 is lowered, however due to its frontal sloping angle the right side wheel support 330 rotates the right wheel 131 backwards, i.e. towards the rear of the scooter, while the bar 280 pushes the left side wheel support 230 to rotate the left wheel 230 frontwards effectively aligning the front wheels for a right turn. Thus the steering of right and left may be achieved by simple tilting of the head bar 140.

In one embodiment, restraining means may be used for returning the front wheel supports 230 and 330 to their initial position, in relations to the frame 260, after the tilting has stopped. For example, a spring or springs may be interposed between the rod 280 and the frame 260 for applying pressure on the rod 280 to sway back the front wheel support parts 230 and 330 into their basic position relative to the frame 260, e.g. to the straight position. In another example, springs may be interposed between the front wheel support parts, 230 and 330, and the frame 260 for applying pressure on the front wheel support parts, 230 and 330 to sway back into their basic position relative to the frame 260, e.g. to the straight position.

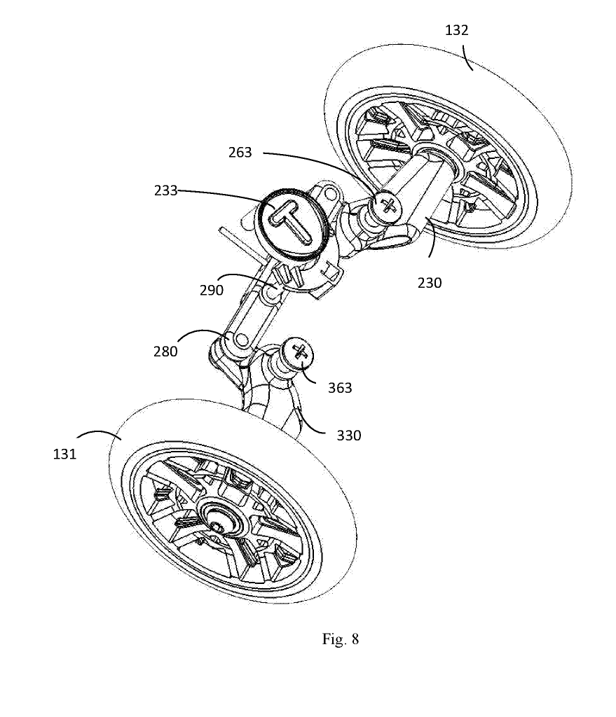

FIGS. 8 depict some of the parts of the steering locking mechanism, described in relations to FIG. 7, according to an embodiment of the invention. The locking mechanism may be used for locking and unlocking the front wheel support parts 230 and 330 in relations to the frame, and thus lock or unlock the front wheel support in relations to the frame. The button 233 may be pushed for locking the steering mechanism to a straight movement position, or pulled for unlocking the steering mechanism, according to one embodiment. As described in relations to FIG. 7, the front wheel support parts 230 and 330 are swayably attached to the front part of the frame around 2 pivots 263 and 363, and thus the front wheel support is swayably attached to the front part of the frame. In addition the front wheel support parts 230 and 330 may be connected by one or more bars, such as bar 280. Thus the steering mechanism may be locked by at least one pin such as by pin 290 which may be located under button 233. Once the button 233 is pushed, its under pin(s), such as pin 290, may be pushed through a hole (not shown) in the front part of the frame and into a designated hole in bar 280, effectively locking the bar 280 to the frame, and thus effectively locking the front wheel support parts 230 and 330 in relations to the frame, which locks the front wheel support in relations to the frame. The button 233 may also have a mechanism which holds it in the locking position, such as a protrusion on one of its pins which interlocks with the front part of the frame, until pulled. Nevertheless, when the turn button 233 is pulled, the pin(s) may be pulled out of the holes in the front wheel supports 230 and 330, effectively allowing the swaying of the front wheel supports 230 and 330 in relations to the frame.

In one embodiment the front wheel support may be molded as one piece. In another embodiment, the front wheel support may be made of a number of parts, such as depicted in relations to FIG. 8. In one embodiment, the front wheel support may be held by a single pivot which allows the swaying, of the front wheel support in relation to the frame. In another embodiment, the front wheel support may be held by two pivots which allow the swaying, of the front wheel support in relation to the frame. In this embodiment, the front wheel support may comprise a number of parts which may sway together around the two pivots for allowing the steering of the scooter. In one embodiment, The front wheel support may comprise two swaying part each swaying around a pivot while another part interlinks the two swaying parts, and coordinates their mutual turn left or right. Thus, as described above, the tilting of the frame and the frame's front part forward slope contribute to the turning, right or left, of the two swaying parts of the front wheel support and the alignment of the front wheels accordingly. For example, by tilting the head bar towards the right, the right side of frame is lowered, and due to its frontal sloping angle the right and left part of front wheel support are swayed to turn right, effectively aligning the front wheels for a right turn.

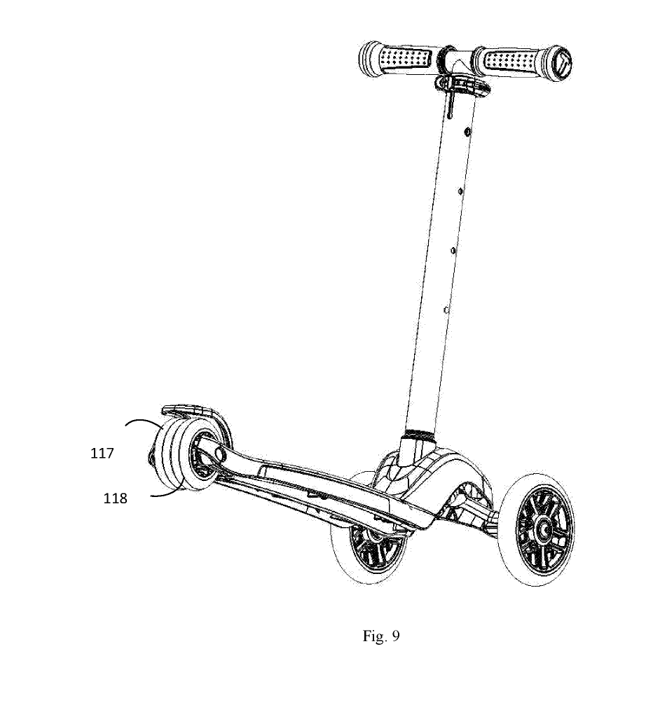

In one embodiment the scooter may have more than 1 rear wheels, such as 2 rear wheels which may be placed about the rear of the footboard of the scooter, such as depicted in FIG. 9. In one embodiment the scooter may have 2 rear wheels, such as 117 and 118, placed together on the same axle at the rear of the footboard of the scooter.

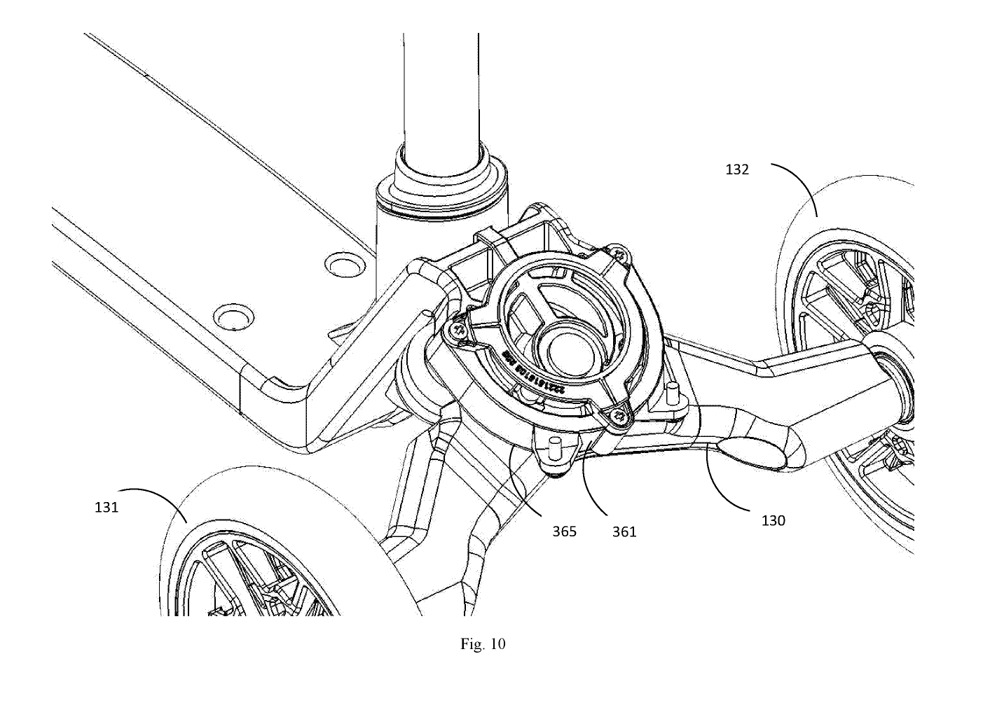

FIG. 10 depicts some of the parts of the steering mechanism, according to another embodiment of the invention. As described in relations to FIG. 3 the front wheel support 130 may have a left front wheel 132 and a right front wheel 131 both rotatably attached to its sides. The front part 361 of the frame may have a smooth surface at its bottom end (not shown), for example a surface made from polyoxymethylene, for a smoothly swaying, of the front wheel support 130 in relation to the frame. The front wheel support 130 may also have a smooth surface 365, for example a surface made from polyamide, at its top for smoothly swaying in relation to the frame. In one embodiment the surfaces polyoxymethylene polyamide and may be reversed or other surfaces may be used for allowing the smooth swaying of the front wheel support 130 in relations to the frame.

While the above description discloses many embodiments and specifications of the invention, these were described by way of illustration and should not be construed as limitations on the scope of the invention. The described invention may be carried into practice with many modifications which are within the scope of the appended claims.

1. A scooter having a lockable steering mechanism comprising:
a rigid frame;
at least one rotatable rear wheel connected to said frame;
at least one front wheel support swayably connected to said frame;
a pair of front wheels each rotatably connected about said at least one front wheel support;
a locking mechanism for locking and unlocking said at least one front wheel support in relations to said frame;
a head bar attached to said frame for steering said scooter when said locking mechanism is unlocked;
restraining means for returning said at least one front wheel support to its initial position in relations to said frame when said locking mechanism is unlocked.

2. A scooter according to claim 1, where the locking of the steering mechanism is done by turning a turn button.

3. A scooter according to claim 1, where the locking of the steering mechanism is done by pushing a button.

4. A scooter according to claim 1, where the restraining means comprise at least one spring.

5. A scooter according to claim 1, where the restraining means comprise at least one elastomer.

6. A scooter according to claim 5, where the elastomer has an “8” like shape.

7. A scooter according to claim 5, where the elastomer has a “B” like shape.

8. A scooter according to claim 5, where the elastomer is replaceable.

9. A scooter according to claim 1, where the footboard is replaceable.

10. A scooter according to claim 1, further comprising a seat on the head bar.

11. A scooter according to claim 1, further comprising a handlebar which is attached to head bar.

12. A scooter according to claim 1, where the scooter has a brake.

13. A scooter according to claim 1, where the locking mechanism comprises one protrusion.

14. A scooter according to claim 1, where the locking mechanism comprises two pins.
